(19) United States
(12) Patent Application Publication
(10) Pub. No.: US 2025/0199160 A1
(43) Pub. Date: Jun. 19, 2025

(54) SYNCHRONIZATION METHOD FOR DIGITAL RADAR SENSORS

(71) Applicant: Robert Bosch GmbH, Stuttgart (DE)

(72) Inventors: Carsten Naber, Gerlingen (DE); Juergen Hasch, Stuttgart (DE)

(21) Appl. No.: 18/951,760

(22) Filed: Nov. 19, 2024

(30) Foreign Application Priority Data
Dec. 19, 2023 (DE) 10 2023 212 973.6

(51) Int. Cl. G01S 13/87; G01S 7/02; G01S 7/40

(52) U.S. Cl. CPC G01S 13/87; G01S 7/0232; G01S 7/4008; G01S 7/4021

(57) ABSTRACT

A multiple-input multiple-output (MIMO) radar network and a method for synchronizing such a network. The method includes synchronizing at least two radar sensors with broadband digital signal generation by emitting at least two multiplex frequency modulated signals with a defined frequency offset by a radar sensor and receiving the signals with another radar sensor. By means of the defined frequency offset, the frequency offset between the radar sensors can be determined or estimated and the clocks can be synchronized with each other.

### CROSS REFERENCE

The present application claims the benefit under 35 U.S.C. § 119 of German Patent Application No. DE 10 2023 212 973.6 filed on Dec. 19, 2023, which is expressly incorporated herein by reference in its entirety.

### FIELD

The present invention relates to a multiple-input multiple-output (MIMO) radar network and a method for synchronizing such a network. In particular, the present invention relates to a method for synchronizing radar networks used in driver assistance systems of motor vehicles for sensing the surroundings and to such radar networks.

### BACKGROUND INFORMATION

For radar networks as a component of driver assistance systems in motor vehicles, modulation methods are typically used that frequency modulate the signals in a chirp method. Modern radar networks are so-called multiple-input multiple-output (MIMO) radar networks that have a plurality of transmitters and a plurality of receivers in the form of radar sensors. For example, each radar sensor can be designed to be both a transmitter and a receiver. The chirp signals (chirps) are transmitted by means of a plurality of transmitters and the reflected signals are received by means of a plurality of receivers. The chirps are generated with voltage-controlled oscillators (VCO) and received signals are demodulated prior to analog-digital conversion by analog mixing with the transmission signal and the bandwidth is thus greatly reduced.

Radar sensors with broadband digital signal generation (hereinafter referred to as digital radar sensors), in which the signals are generated directly by digital-to-analog converters having sample rates of at least several hundred MHz, for example more than 200 MHz, with a predefined local oscillator (LO), are used as well. Reflected signals are also mixed with a predefined local oscillator and provided for evaluation by means of an analog-to-digital converter having sample rates of at least several hundred MHz, for example more than 200 MHz, without prior analog demodulation. Thus, such digital radar sensors can work with a large number of modulation methods, which significantly increases their spectrum of use over analog radar sensors. Also, they are able to receive the full bandwidth or large portions of the bandwidth of the signal spectrum utilized in a radar network at one time and have very good temporal resolution. In multiple-input multiple-output (MIMO) radar networks with digital radar sensors, a commonly used modulation method for generating the transmission signals is frequency-division multiplexing (FDM), for example as orthogonal frequency-division multiplexing (OFDM).

The individual radar sensors each have their own clocks for signal generation and processing. As an increasing number of individual radar sensors are being installed in motor vehicles with driver assistance systems, synchronization of these radar sensors or their clocks may be required, in particular to avoid interference between the radar sensors and to enable coherent signal processing of the signals from the different sensors and to operate the radar network as a cooperative radar. Moreover, the respective clocks are subject to a drift of their clock frequency, for example a temperature drift. Therefore, regular synchronization of the clocks may be required.

### SUMMARY

An object of the present invention is to provide a synchronization method for clock synchronization of a plurality of digital radar sensors when every sensor has its own clock. A further object of the present invention is to make such a method possible in a simple and cost-efficient manner without additionally required hardware components for connecting the radar sensors. A further object of the present invention is to provide a radar network for operation with such a synchronization method.

According to the present invention, these objects may be achieved with a method and a radar network having certain features of the present invention, Advantageous example embodiments and further developments of the present invention are disclosed herein.

A synchronization method according to an example embodiment of the present invention for at least two digital radar sensors includes the following steps:
sending at least two signals with a first radar sensor, wherein the signals are derived from the same or synchronous clocks of the transmitting radar sensor, wherein the signals are modulated in a frequency-division multiplexing process and have the same frequency profile during the joint transmission and have a defined frequency offset Δf to each other; receiving the transmitted signals by at least one further radar sensor;
carrying out a complex frequency conversion into an intermediate frequency band suitable for digitization; carrying out an analog-digital conversion of the received signals into a complex digital signal; conjugating the complex signal to obtain a complex conjugated signal; mixing the complex signal with the complex conjugated signal to obtain a signal, which contains the frequency offset Δf of the received signals as a main frequency component; mixing the signal with a complex sine wave or a complex square wave signal, wherein the complex sine wave or the complex square wave signal having the defined frequency offset Δf is generated as the target frequency from a local clock of the at least one further receiving radar sensor; filtering the obtained signal to obtain the main frequency component; controlling, with a control loop, all clocks of the at least one further receiving radar sensor using the main frequency component, such that the clocks of the at least one further receiving radar sensor are synchronous with the clocks of the transmitting radar sensor; or correcting the transmitted signals and/or the received signals based on an estimate of the frequency offset between the transmitting radar sensor and the at least one further receiving radar sensor based on the main frequency component.

By deriving the transmitted signals from the same or synchronous clocks of the transmitting radar sensor, the frequency offset of the signals corresponds to the defined frequency offset.

Typically, for applications in driver assistance systems, Δf<<f_{c} applies, where f_{c} is the carrier frequency of the radar signal. In these cases, the frequency offset Δf is only marginally affected by the Doppler shift generated by the reflection of the signals at a target because the Doppler shift affects the different components of the frequency multiplexed signal nearly identically. Also, the signal propagation time does not affect the received frequencies of the signal. Thus, the frequency offset of the received signals substantially corresponds to the defined frequency offset of the transmitted signals.

The at least one further receiving radar sensor (hereinafter the term “the receiving radar sensor” means, but is not limited to, at least one further receiving radar sensor and can also include a plurality of further receiving radar sensors) receives the complete bandwidth of the signals being mixed into the complex baseband and can convert the complete baseband bandwidth from analog to digital. The radar sensors operated with the method according to the invention are preferably radar sensors with broadband digital signal generation (digital radar sensors). Conjugation of the complex signal to obtain the complex conjugated signal is performed by inversion of the sign of the imaginary portion of the complex signal.

The complex signal is mixed with the complex conjugated signal by a complex multiplier. The signal thus obtained contains the frequency offset Δf of the received signals, i.e., the defined frequency offset of the transmitted signals, as the difference frequency, which forms the main frequency component of the signal.

The mixing of the signal containing the frequency offset Δf of the received signals as a main frequency component with a complex sine wave or a complex square wave signal generated using the defined frequency offset Δf results in a signal having a main frequency component close to 0 Hz. This results from the fact that the complex sine wave is generated from a local clock signal of the receiving radar sensor by means of a numerically controlled oscillator (NCO) or the complex square wave signal is generated from a local clock signal of the receiving radar sensor by means a square wave generator. The use of a square wave generator instead of an NCO reduces the cost of a corresponding radar sensor.

The differences in the clock frequencies of the clocks of the transmitting radar sensor and the clocks of the receiving radar sensor—which are produced as described by the respective drift of their clock frequencies—result in a frequency offset between the transmitting radar sensor and the receiving radar sensor. The defined frequency offset −Δf is used in the receiving radar sensor as the target frequency to generate the complex sine wave or the complex square wave signal. Because the complex sine wave or the complex square wave signal is generated using a local clock and this is not synchronous with the clocks of the transmitting radar sensor, the actual frequency of the complex sine wave or the complex square wave signal deviates from the defined frequency offset Δf of the transmitting radar sensor corresponding to the frequency offset between the radars.

Put another way, the defined frequency offset Δf of the transmitting radar sensor does not correspond to the actual frequency offset Δf_{Rx} of the receiving radar sensor. Thus, a mixing of a complex sine wave or complex square wave signal with the actual frequency offset −Δf_{Rx} as the frequency with the received signal containing the frequency offset Δf of the received signals as a main frequency component does not result in exactly 0 Hz.

This can be illustrated with an example: With a frequency offset of 1% between the transmitting radar sensor and the receiving radar sensor and a defined frequency offset of 50 MHz between the transmitted signals, a deviation of +0.5 Hz results after mixing with the complex sine wave or the complex square wave signal when the clocks of the transmitting radar sensor are 1% faster than the clocks of the receiving radar sensor.

Accordingly, a deviation of −0.5 Hz results when the clocks of the transmitting radar sensor are 18 slower than the clocks of the receiving radar sensor.

The main frequency component of the mixed signal, whose deviation of 0 Hz results from the deviation between the radar sensors, is preferably filtered by means of a low-pass filter, e.g. by means of a moving average filter.

The filtered main frequency component can now either be used to control all clocks of the at least one further receiving radar sensor by means of a control loop, or it can be used to correct the transmitted signals and/or the received signals based on an estimate of the frequency offset between the transmitting radar sensor and the at least one further receiving radar sensor. Preferably, the transmitted signals and/or the received signals of the receiving radar sensor are corrected, but also the transmitted signals and/or the received signals of the transmitting radar sensor can be corrected. In such a case, the method comprises a step of exchanging data between the receiving and transmitting radar sensor. The method of the present invention is not limited to either the control or the correction; the steps can be combined and performed simultaneously or in any order. For example, a controller can synchronize all clocks of the at least one further receiving radar sensor to the clocks of the transmitting radar sensor and any technically resulting residual deviations can be corrected upon generation of the transmitted signals and/or the received signals using the estimate of the frequency offset.

In this case, synchronous does not mean exactly synchronous but approximately synchronous. Depending on the intended use of a radar network synchronized with the method, this can comprise a technically tolerable deviation of a few Hz. Further deviations can result, for example, from a continuing temperature drift of the clocks of the individual radar sensors.

The control loop is preferably a phase-locked loop (PLL) and/or frequency-locked loop (FLL). Depending on the embodiment of the method of the present invention, for example, one can switch between a PLL and a FLL or these can be combined or utilized simultaneously.

According to a preferred example embodiment of the present invention, the synchronization method comprises a holding signal, which pauses the control of all clocks by means of a control loop and/or the correction of the transmitted signals and/or the received signals based on an estimate of the frequency offset if no suitable input signal is present.

According to an example embodiment of the present invention, preferably, the holding signal is controlled by a threshold detector, which receives the signal filtered by the filtering to obtain the main frequency component as an input signal and pauses the control loop in the case of an input signal below a threshold. Preferably, the holding signal is also and/or alternatively controlled by an interference detection of the radar sensor and the control loop is paused in the case of an interference signal. For example, the holding signal is controlled by a threshold detector that receives the filtered main frequency component as the input signal. In the case of a signal having a power above a defined threshold, the control loop and/or correction of the signals is activated and otherwise paused.

The output signal of the threshold detector can also be used for a plausibility test, which checks whether the received signals are not interferences. This, as well as controlling the holding signal via interference detection, increases the robustness of the method according to the invention.

According to a further preferred example embodiment of the present invention, the control loop comprises an adjustable reference oscillator and all clock signals of the at least one further receiving radar sensor are derived from the reference oscillator.

The adjustable reference oscillator is set in the control loop and is preferably corrected to the setpoint. Preferably, the clock signals for the complex frequency conversion and for the carrier frequency of the receiving radar sensor are derived from the reference oscillator; this can be the same frequency. Further preferably, the clock signal for the logical clock of the receiving radar sensor is derived from the reference oscillator; this can also be a PLL or a clock splitter, for example.

According to a further preferred example embodiment of the present invention, the setting of the reference oscillator is performed by a digital-to-analog converter and a control voltage generated thereby or by a configuration parameter. This depends on the type of reference oscillator used. For example, the output signal of a loop filter of the control loop is used as the input signal for the digital-to-analog converter.

According to a further preferred example embodiment of the present invention, the control loop comprises frequency generation with direct digital synthesis (DDS), and from the DDS, all clock signals of the at least one further receiving radar sensor are derived.

According to an example embodiment of the present invention, preferably, at least the clock signals for the complex frequency conversion and for the carrier frequency of the receiving radar sensor are derived from the DDS; this can be the same frequency. Further preferably, the DDS is used to set the logical clock of the receiving radar sensor; this can also be a PLL or a clock splitter, for example. For example, the output signal of a loop filter of the control loop is used as the control word for the DDS, whereby the frequency generation of the DDS is set and further preferably corrected to the setpoint.

According to a further preferred example embodiment of the present invention, when correcting the transmitted signals and/or the received signals, the baseband of the transmitted signals and/or the received signals is mixed with a complex sine wave, wherein the complex sine wave is generated with the estimated frequency offset Δf_{E} as the target frequency of a clock.

The complex sine wave is in this case generated, for example, by means of an NCO of the receiving radar sensor. Preferably, the complex sine wave is complex conjugated prior to mixing with the transmission signals.

According to a further preferred example embodiment of the present invention, the generation of transmitted signals and/or the processing of received signals is further corrected using the estimate of the frequency offset.

The present invention further comprises a synchronization method according to one of the described example embodiments, wherein each of the at least two signals is transmitted by a respective transmission antenna of the first radar sensor and the at least two transmission antennas of the first radar sensor are arranged at a distance from each other; wherein the at least one further receiving radar sensor receives the transmitted signals with more than one receiving antenna; wherein the number and the distance of the receiving antennas corresponds to the number and the distance of the transmitting antennas; wherein the analog-digital conversion converts the received signals into a complex digital signal of a first receiving antenna and a complex signal of at least one further receiving antenna; wherein the conjugation of the complex signal to obtain a complex conjugated signal is performed by conjugation of the complex signal of one of the receiving antennas to obtain the complex conjugated signal; and
wherein mixing the complex signal with the complex conjugated signal to obtain a signal containing the frequency offset Δf of the received signals as a main frequency component is performed by mixing the complex conjugated signal with the complex signal of another receiving antenna.

When using more receiving antennas than transmission antennas, the signals from two of the receiving antennas are in each case mixed together accordingly and the result of the method of all comparisons is mixed together to obtain a mean.

The present invention further comprises a radar network having at least a first and a second digital radar sensor. With the radar network, the method according to any of the example embodiments or further developments described above is performed. Each radar sensor preferably comprises at least one transmission antenna and at least one receiving antenna, which can be designed as conventional radar antennas and which can further be designed such that each transmission antenna is simultaneously a receiving antenna. For example, each radar sensor includes at least two transmission and/or receiving antennas arranged at a distance from each other. Digital radar sensors refer to radar sensors with broadband digital signal generation in which the signals are processed by means of digital-to-analog converters and analog-to-digital converters with sample rates of at least several 100 MHz, for example more than 200 MHZ.

Preferred embodiments of the present invention are explained in more detail below with reference to the figures.

### BRIEF DESCRIPTION OF THE DRAWINGS

FIG. 1 shows a block diagram of the synchronization method according to the present invention according to a first example embodiment.

FIG. 2A-2E show signals in various steps of the synchronization method according to the present invention according to the first example embodiment.

FIG. 3 shows a block diagram of the synchronization method according to the present invention according to a second example embodiment.

FIG. 4 shows a block diagram of the synchronization method according to the present invention according to a third example embodiment.

FIG. 5 shows the correction of the frequency deviation between the transmitting radar sensor and the receiving radar sensor according to the third example embodiment of the present invention.

FIG. 6 shows two radar sensors of a fourth preferred example embodiment of the method of the present invention.

FIG. 7 shows a block diagram of the synchronization method according to the present invention according to the fourth example embodiment.

FIG. 8A-8C show signals in various steps of the synchronization method according to the present invention according to the fourth example embodiment.

### DETAILED DESCRIPTION OF EXAMPLE EMBODIMENTS

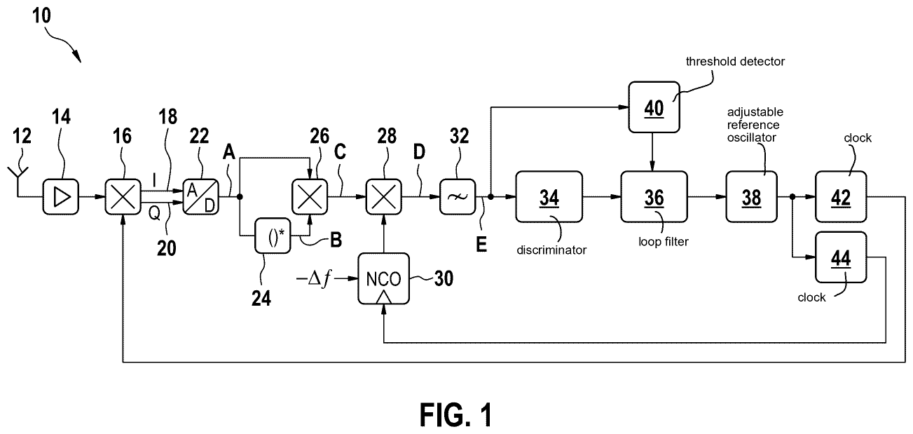

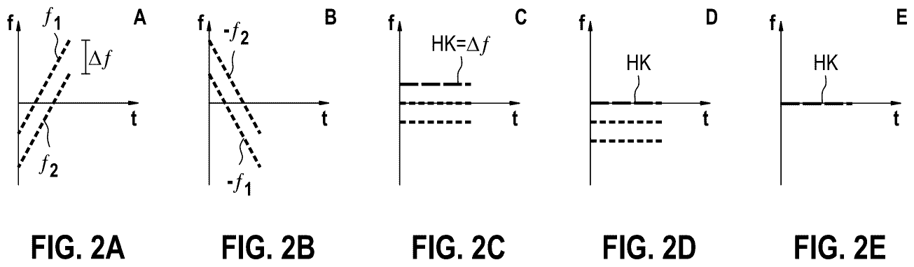

FIG. 1 shows a block diagram 10 of the synchronization method according to the invention according to a first embodiment of the invention. The block diagram 10 shows the reception of the transmitted signals by at least one receiving radar sensor and the subsequent signal processing. The receiving radar sensor receives the signal through a radar antenna (Rx) 12. The received signal is amplified by means of an amplifier 14 and mixed into the complex baseband by means of an in-phase & quadrature mixer (I&Q mixer) 16. In the I&Q mixing process, the received signal is on the one hand mixed with the carrier frequency generated by the local oscillator in unchanged phase position and yields the I data 18. Simultaneously, the signal is mixed with a carrier frequency that is phase-shifted by 90° and yields the Q data 20. This causes the complex frequency conversion into an intermediate frequency band suitable for digitization. The obtained signals are converted to a digitized complex signal A (see FIG. 2A) by means of an analog-to-digital converter 22 with sample rates of at least several 100 MHZ, for example more than 200 MHZ.

FIG. 2A shows the two digitized signals f₁ and f₂, which were transmitted and received simultaneously, i.e., together, with the same ramp duration and the same ramp angle, and are offset from each other by the frequency offset Δf.

The complex signal A is subsequently complex conjugated by a conjugator 24, wherein the sign of the imaginary portion is inverted, and the complex conjugated signal B is obtained (see FIG. 2B).

FIG. 2B shows the complex conjugated signal B wherein the sub-signal −f₁ corresponds to the unconjugated sub-signal f₁ and the sub-signal −f₁ corresponds to the unconjugated sub-signal f₁. The complex signal A is mixed with the complex conjugated signal B by a complex multiplier 26. Due to the analog-to-digital conversion 22 having been performed, both the complex conjugation and the mixing with a complex multiplier and the subsequent steps can be implemented and performed fully digitally. Signal C (see FIG. 2C) obtained by mixing contains a main frequency component HK. This represents the difference frequency of the received signals A and corresponds to the frequency offset Δf.

Subsequently, signal C is mixed by a mixer 28 with a complex sine wave generated by an NCO 30. The NCO generates the complex sine wave with the defined frequency offset −Δf as the target frequency. This frequency is provided to the NCO by a local clock.

The target frequency and thus the defined frequency offset Δf of the receiving radar sensor can deviate from the target frequency and the defined frequency offset Δf of the transmitting radar sensor. This is due to the drift of the respective clocks of the radar sensors, which can cause the actual frequencies and thus also the actual frequency offsets to deviate from one another.

Due to the process involved, only the deviation of the clocks of the receiving radar sensor from the clocks of the transmitting radar sensor is determined. The deviation of the actual frequency of the clocks of the transmitting radar sensor from the theoretically determined defined frequency offset is not relevant for the synchronization method. If the frequency offset of the transmitting radar sensor is Δf and the actual frequency offset of the receiving radar sensor is Δf_{Rx}, then Δf≠Δf_{Rx}.

Thus, the complex sine wave generated by the NCO does not exactly correspond in its frequency to the frequency offset of the received signals, as signal C, with the frequency offset Δf as the main component HK. By mixing the complex sine wave with signal C by means of the mixer 28, a signal D (see FIG. 2D) results, which has a main component HK that is near zero Hz but has a frequency offset to zero Hz. This frequency offset corresponds to Δf_{Rx} and results from the frequency offset between the transmitting and the receiving radar sensor and the defined frequency offset Δf.

The main component HK can then be filtered with a filter 32, preferably by a low-pass filter, for example by a moving average filter. The obtained signal E (see FIG. 2E) comprises only the main component HK.

Signal E is now used as an input signal of a frequency control loop comprising a discriminator 34 and a loop filter 36 and an adjustable reference oscillator 38. Depending on the embodiment of the discriminator 34, the control loop is a phase-locked loop (PLL) or frequency-locked loop (FLL). The control loop can also be a combination of PLL and FLL, and it is possible to switch between the types. The exact embodiment determines the speed of the control loop, i.e. the response time.

The output signal of the loop filter 36 serves as an input signal and thus as a control signal of the adjustable reference oscillator 38. This can be a voltage-controlled oscillator (VCO). In that case, the output signal of the loop filter 36 controls a digital-to-analog converter (not shown here) that generates a control voltage as an input signal for the reference oscillator 38. The adjustable reference oscillator 38 can be a numerically controlled oscillator (NCO). In that case, the output signal of the loop filter 36 is a control value or configuration parameter. The loop filter 36 corrects the adjustable reference oscillator 38 to the setpoint.

The synchronization method according to the invention comprises a threshold detector 40, which generates a holding signal for the control loop. The threshold detector 40 receives the signal E as an input signal and activates the control loop when the power of the signal E is above a defined threshold. If there is no signal with corresponding power, the threshold detector 40 pauses the control loop via the loop filter 36. Thus, in the event of erroneous signals due to interferences or lack of transmitted synchronization signals, the control loop can be paused and incorrect adjustment of the reference oscillator 38 prevented.

The clock signals for the clocks 42, 44 of the receiving radar sensor are subsequently derived from the adjustable reference oscillator 38, which generate the carrier frequency of the radar signal and the I&Q mixing process, for example. The clock 42 is, for example, a PLL for generating the carrier frequency of the radar signal and thus the carrier frequency of the I&Q mixing process. And, for example, the clock 44 is the logical clock of the receiving radar sensor that acts as the clock for the NCO 30. The logical clock can be, for example, a PLL or a clock splitter.

The control loop sets the reference oscillator 38 to be synchronous with the clocks of the transmitting radar sensor from which the transmitted signals are derived. By the fact that the clocks 42, 44 of the receiving radar sensor are corrected by tracking the adjustable reference oscillator 38, they are also synchronized to the clocks of the transmitting radar sensor. This enables accurate and interference-free operation of the radar sensors and coherent signal processing of the different radar sensors.

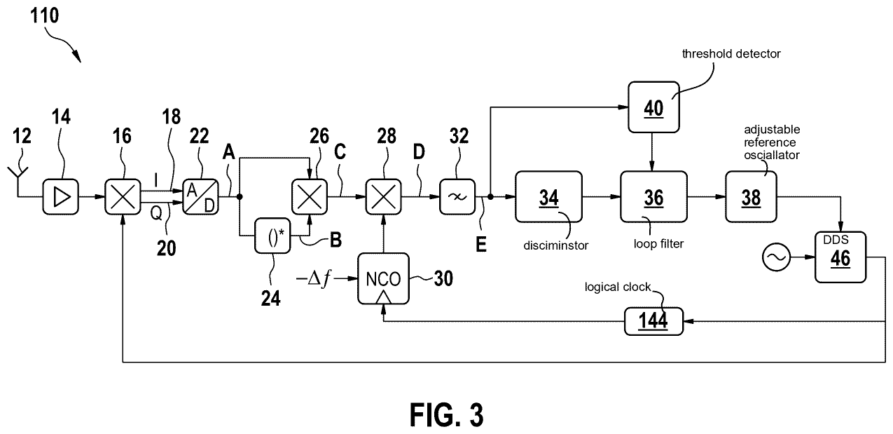

FIG. 3 shows a block diagram 110 of a second embodiment of the invention. Regarding the parts that are identical to the first embodiment, reference is made below to the description of these parts and repetition is omitted.

In the second embodiment, the control loop comprises a direct digital synthesis (DDS) 46 instead of an adjustable reference oscillator. From the DDS, the clock signals of the receiving radar sensor are derived, these generating the carrier frequency of the radar signal and the I&Q mixing process, for example. Furthermore, the clock signal for the logical clock 144 is derived from this DDS, which logical clock 144 may be a clock splitter, for example. For example, the logical clock 144 is a clock for the NCO 30.

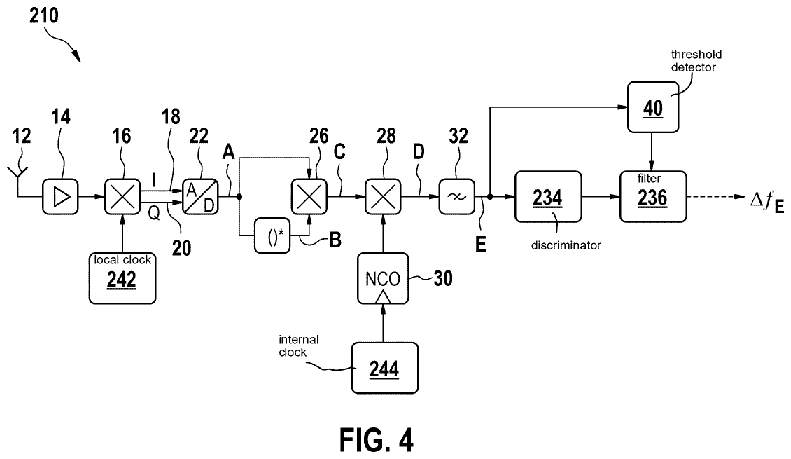

FIG. 4 shows a block diagram 210 of a third embodiment of the invention. Regarding the parts that are identical to the first embodiment, reference is made to the description of these parts and repetition is omitted.

In FIG. 4, the output signal of the filter 32 is used to estimate the frequency offset between the radars, i.e., the deviation of the frequency offset of the receiving radar from the frequency offset of the transmitting radar. The current frequency offset is estimated by a discriminator 234 and filtered by a filter 236 over a defined time period. For example, the estimated deviation Δf_{E} is averaged.

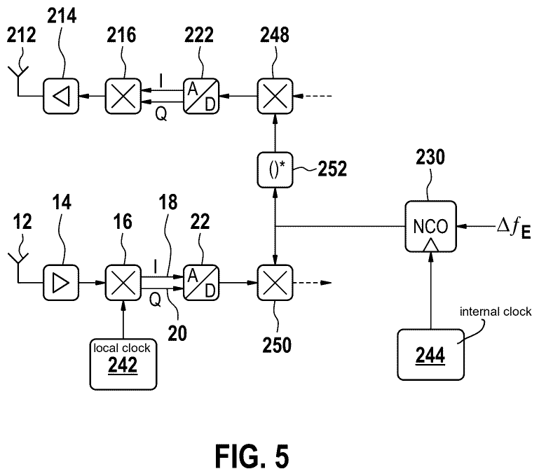

As shown in FIG. 5, the output signal of the filter 236, for example the estimated deviation Δf_{E}, is subsequently used as the target frequency for setting an NCO 230, wherein an internal clock 244—for example the logical clock of the receiving radar sensor—functions as the clock for the NCO 230. The NCO can be, for example, the NCO 30, but can also be a dedicated NCO.

The NCO 230 generates a complex sine wave at the target frequency Δf_{E}, which is then mixed using the mixers 248 and 250 into the respective baseband of the transmitting radar sensor and the receiving radar sensor, respectively. The complex sine wave is complex conjugated prior to being mixed into the digital baseband of the transmitting radar sensor using a conjugator 252. The embodiment is not limited to being mixed into both the baseband of the transmitting and the receiving radar sensor; it is also possible to perform the synchronization by correcting only the signals of one of the two.

Frequency deviations that continue to exist between the transmitting radar sensor and the receiving radar sensor can be corrected when generating transmission signals and/or processing received signals using the estimate of the frequency offset.

The generation of transmission signals further comprises the method blocks of digital-to-analog conversion by means of a digital-to-analog converter 222, performing the I&Q mixing process by means of an I&Q mixer 216, amplification by means of an amplifier 214, and transmitting the transmission signals by means of a radar antenna (Tx) 212. The carrier frequency of the radar signal and/or the I&Q mixing process is generated in the receiving radar sensor by a local clock 242.

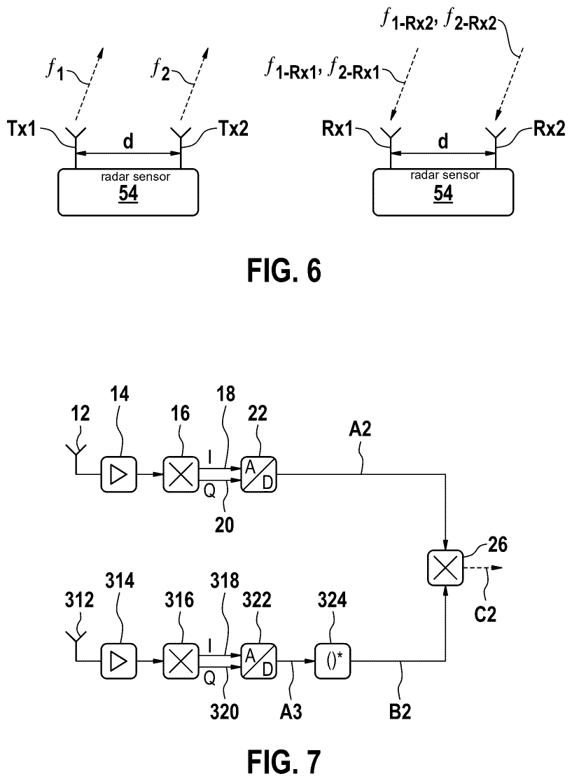

FIG. 6 shows two radar sensors of a fourth preferred embodiment of the method. In this embodiment of the method, each of the two transmission signals f₁, f₂ is transmitted through one of two antennas Tx1, Tx2 of the transmitting radar sensor 54. The antenna Tx1 transmits signal f₁ and the antenna Tx2 transmits signal f₂. The antennas are arranged at a distance d from each other.

Signals f₁, f₂ are received by the receiving radar sensor 56 with antennas Rx1 and Rx2, each antenna Rx1, Rx2 receives both signals, so Rx1 receives signals f_{1-Rx1} and f_{2-Rx1} and Rx2 receives signals f_{1-Rx2} and f_{2-Rx2}. Due to the fact that the radar sensor 56 receives the reflection of the signals f₁, f₂, there is an angle-dependent phase difference between the respective received signals due to the distance d between the transmission antennas Tx1, Tx2. To eliminate this for the synchronization method, the transmitted signals are received by the antennas Rx1 and Rx2, which are also at the distance d from each other, and the synchronization method is performed as shown in FIG. 7.

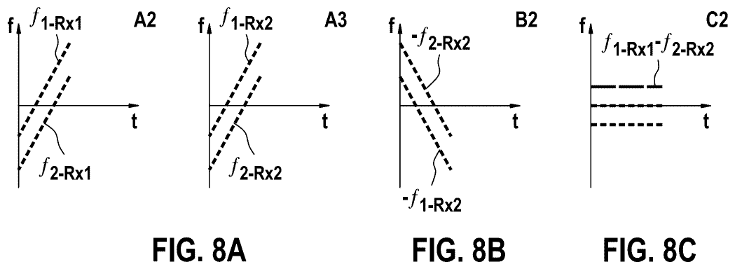

In FIG. 7, signals f₁ and f₂ are respectively received by antennas 12, 312 (Rx1, Rx2). The method is not defined by the antenna 12 corresponding to the antenna Rx1 and the antenna 312 corresponding to the antenna Rx2. The received signals are each amplified with an amplifier 14, 314 and mixed into the complex baseband by means of an I&Q mixer 16, 316. By modulation according to the in-phase & quadrature method, the corresponding signal is mixed with the unchanged phase position and yields the I data 18, 318. Simultaneously, the signal is mixed with a carrier frequency that is phase-shifted by 90° and yields the Q data 20, 320. These are converted to a digitized complex signal A2 or A3 (see FIG. 8A) by means of an analog-to-digital converter 22, 322 with sample rates of at least several 100 MHZ, for example more than 200 MHZ.

FIG. 8A shows the two digitized signals f_{1-Rx1}, f_{2-Rx1} and f_{1-Rx2}, f_{2-Rx2}, respectively.

The complex signal A3 is subsequently complex conjugated by a conjugator 324, wherein the sign of the imaginary portion is inverted and the complex conjugated signal B2 is obtained. FIG. 8B shows the complex conjugated signal B2 wherein the sub-signal −f_{1-Rx2} corresponds to the unconjugated sub-signal f₁ and the sub-signal −f_{2-Rx2} corresponds to the unconjugated sub-signal f₂. The complex signal A2 is mixed with the complex conjugated signal B2 by the complex multiplier 26. Both complex conjugation and mixing with a complex multiplier and the subsequent steps can be implemented and performed fully digitally due to the analog-to-digital conversion 22, 322 having been performed. The signal C2 obtained by mixing (see FIG. 8C) contains a main frequency component f_{1-Rx1}−f_{2-Rx2}. This represents the difference frequency of the transmitted signals and corresponds to the frequency offset Δf.

The following steps of the fourth embodiment of the method can be carried out according to any of the first to third embodiments of the method and are, therefore, not shown further here.

The method according to the invention according to any of the described embodiments can also be carried out with a plurality of radar sensors in a radar network. One radar sensor transmits the described synchronization signals and each of the plurality of receiving radar sensors performs the method according to the invention. The adjustment of the transmitted signals can be carried out in a suitable manner; for example an average of the estimated deviation of all the receiving radar sensors is used as the correction value of the transmission signals.

The disclosed embodiments are not limited to their respective features but can, as far as technically possible, be combined with one another in any manner.

What is claimed is:

1. A synchronization method for at least two digital radar sensors, comprising the following steps:
transmitting at least two signals with a first radar sensor, wherein the signals are derived from a same or synchronous clocks of the transmitting radar sensor, wherein the signals are modulated in a frequency-division multiplexing process and have a same frequency profile during a joint emission and have a defined frequency offset to each other;
receiving the transmitted signals by at least one further radar sensor;
carrying out a complex frequency conversion into an intermediate frequency band suitable for digitization;
carrying out an analog-digital conversion of the received signals into a complex digital signal;
conjugating the complex signal to obtain a complex conjugated signal;
mixing the complex signal with the complex conjugated signal to obtain a signal containing the frequency offset of the received signals as a main frequency component;
mixing the signal with a complex sine wave or a complex square wave signal, wherein the complex sine wave or the complex square wave signal having the defined frequency offset is generated as a target frequency from a local clock of the at least one further receiving radar sensor;
filtering the obtained signal to obtain the main frequency component; and:
(i) controlling, with a control loop, all clocks of the at least one further receiving radar sensor using the main frequency component such that the clocks of the at least one further receiving radar sensor are synchronous with clocks of the transmitting radar sensor, or (ii) correcting the transmitted signals and/or the received signals based on an estimate of the frequency offset between the transmitting radar sensor and the at least one further receiving radar sensor based on the main frequency component.

2. The synchronization method according to claim 1, wherein: (i) a holding signal pauses control of all clocks using the control loop or (ii) the transmitted signals and/or the received signals are corrected based on an estimate of the frequency offset when no suitable input signal is present.

3. The synchronization method according to claim 2, wherein the control loop includes an adjustable reference oscillator, and wherein all clock signals of the at least one further receiving radar sensor are derived from the reference oscillator.

4. The synchronization method according to claim 3, wherein a setting of the reference oscillator is performed: (i) by a digital-to-analog converter and a control voltage generated using the digital-to-analog converter, or (ii) using a configuration parameter.

5. The synchronization method according to claim 1, wherein the control loop includes frequency generation with a direct digital synthesis, and wherein all clock signals of the at least one further radar receiving radar sensor are derived from the direct digital synthesis.

6. The synchronization method according to claim 1, wherein, when correcting the transmitted signals and/or the received signals, a baseband of the transmitted signals and/or the received signals is mixed with a complex sine wave, wherein the complex sine wave is generated with the estimated frequency offset as the target frequency of a clock.

7. The synchronization method according to claim 6, wherein generation of transmitted signals and/or processing of received signals is further corrected using the estimate of the frequency offset.

8. The synchronization method according to claim 1, wherein:
each of the at least two signals is transmitted by a respective transmission antenna of the first radar sensor and the transmission antennas of the first radar sensor are arranged at a distance from each other;
wherein the at least one further receiving radar sensor receives the transmitted signals with more than one receiving antenna, wherein a number and distance of the receiving antennas correspond to a number and the distance of the transmission antennas;
wherein the analog-digital conversion converts the received signals into a complex digital signal of a first receiving antenna and a complex signal of at least one further radar receiving antenna;
wherein the conjugation of the complex signal to obtain a complex conjugated signal is performed by conjugation of the complex signal of one of the receiving antennas to obtain the complex conjugated signal; and
wherein the mixing of the complex signal with the complex conjugated signal to obtain a signal containing the frequency offset of the received signals as a main frequency component is performed by mixing the complex conjugated signal with the complex signal of another receiving antenna.

9. The synchronization method according to claim 1, wherein: (i) the complex sine wave is generated by a numerically controlled oscillator, or (ii) the complex square wave signal is generated by a square wave generator.

10. A radar network, comprising:
at least a first digital radar and a second digital radar sensor, which are synchronized by:
transmitting at least two signals with a first radar sensor of the first and second digital radar sensors, wherein the signals are derived from a same or synchronous clocks of the transmitting radar sensor, wherein the signals are modulated in a frequency-division multiplexing process and have a same frequency profile during a joint emission and have a defined frequency offset to each other;
receiving the transmitted signals by at least one further radar sensor of the first and second digital radar sensor;
carrying out a complex frequency conversion into an intermediate frequency band suitable for digitization;
carrying out an analog-digital conversion of the received signals into a complex digital signal;
conjugating the complex signal to obtain a complex conjugated signal;
mixing the complex signal with the complex conjugated signal to obtain a signal containing the frequency offset of the received signals as a main frequency component;
mixing the signal with a complex sine wave or a complex square wave signal, wherein the complex sine wave or the complex square wave signal having the defined frequency offset is generated as a target frequency from a local clock of the at least one further receiving radar sensor;
filtering the obtained signal to obtain the main frequency component; and:
(i) controlling, with a control loop, all clocks of the at least one further receiving radar sensor using the main frequency component such that the clocks of the at least one further receiving radar sensor are synchronous with clocks of the transmitting radar sensor, or (ii) correcting the transmitted signals and/or the received signals based on an estimate of the frequency offset between the transmitting radar sensor and the at least one further receiving radar sensor based on the main frequency component.
